(19) United States
(12) Patent Application Publication
(10) Pub. No.: US 2007/0073933 A1
(43) Pub. Date: Mar. 29, 2007

(54) Asynchronous interface with vectored interface controls

(75) Inventors: Charles David Wait, Byron, MN (US); Alfred Thomas Watson III, Rochester, MN (US)

Correspondence Address: MARTIN & ASSOCIATES, LLC, P.O. BOX 548, CARTHAGE, MO, 64836-0548, US

(73) Assignee: International Business Machines Corporation, Armonk, NY (US)

(21) Appl. No.: 11/225,643

(22) Filed: Sep. 13, 2005

(51) Int. Cl. G06F 3/00

(52) U.S. Cl. 710/58

(57) ABSTRACT

An asynchronous interface that uses vectored interface commands to reduce the latency of registered communication interface signals. In preferred embodiments, vectored commands are communicated between clock domains with handshake command signals comprising command valid and command acknowledge signals. Each command is assigned a sequential number up to a maximum number of outstanding commands. For each command number, there are a dedicated command valid and acknowledge signal pair. Command valid is sent to indicate a command is ready to be processed and acknowledge is received indicating the command is done. In preferred embodiments, each side of the asynchronous interface independently tracks the next valid/acknowledge signal pair that will be used.

### BACKGROUND OF THE INVENTION

1. Technical Field

This invention generally relates to digital communication interfaces, and more specifically relates to improving the performance of an asynchronous interface using vectored interface controls.

2. Background Art

In digital computer systems there is often an interface connecting a primary system to one or more external systems. FIG. 5 represents a prior art digital computer system 500 that connects a primary system 510 to an external system 520 over an interface 530. In many digital computer system, the external system 520 is asynchronous to the primary system. In other words, the clock of the external system 520 is not tied to the clock mechanism of the primary system 510, but operates independently and asynchronously to the primary system 510. Signals from the primary system 510 to an external system are then asynchronous inputs to the logic of the external system 520 and vise versa.

Asynchronous inputs can be problematic for the basic elements of a computer system, particularly digital logic components. For example, an asynchronous input to a flip-flop that violates the setup and hold times of the device may cause the flip-flop to go to an unknown state or otherwise become unpredictable. This unpredictable state is referred to as metastable. In fact, such metastable behavior is expected. Specifications for flip-flops, for example, include statistical parameters, which allow system designers to calculate information such as Mean Time Between Failures, or MTBF. The MTBF of a device indicates the likelihood of a metastable condition occurring in the device.

To avoid a metastable condition, the signal being received by the circuit, or input signal, is expected to not change and to maintain a proper logic level while being sampled. The setup time is the time just prior to a clock transition for the sample. The input signal is expected to remain stable for the setup time period or greater prior to the clock transition. The hold time, is the time just after the clock transition. The input signal is expected to remain stable for a hold time period or greater after the clock transition. Changes to the input signal that occur between the setup time and the hold time may produce unpredictable results.

Asynchronous inputs may produce metastability. Since an asynchronous input can change at any time relative to the clock, the input may be change between the setup time and the hold time. Various design techniques may reduce the probability of a metastable event occurring, but do not eliminate metastability. In some environments, metastability adversely affects system reliability. Where unexplained system crashes and other unresolved failures occur, metastability may be the culprit.

Logic designers include circuitry, such as synchronizers, to minimize the possibility of a metastable output from a circuit. In many prior art asynchronous systems, signals going between asynchronous clock domains are synchronized to avoid metastability problems in the receiving clock domain by passing the signals through a series of latched registers. Multiple latching to avoid metastability has the disadvantage of increased cycles of latency for signal handshaking communication which reduces hardware performance.

Without a better way to reduce the latency caused by registering circuits to avoid metastability in asynchronous systems the computer industry will continue to suffer from reduced system performance in asynchronous systems.

### DISCLOSURE OF INVENTION

According to preferred embodiments, an asynchronous interface is described that uses vectored interface commands to reduce the latency of registered communication interface signals. The term vectored interface commands is used herein to mean an array of command handshaking signals. In preferred embodiments, vectored commands are communicated between clock domains with an array of handshake command signals comprising command valid and command acknowledge signals. Each command is assigned a sequential number up to a maximum number of outstanding commands. For each command number, there are a dedicated command valid and acknowledge signal pair. Command valid is sent to indicate a command is ready to be processed and acknowledge is received indicating the command is done. In preferred embodiments, each side of the asynchronous interface independently tracks the next valid/acknowledge signal pair that will be used.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a system level block diagram of a digital system with a bus between a primary system and an external system according to preferred embodiments;

FIG. 2 is a detailed block diagram of an interface according to a preferred embodiment;

FIG. 3 is a timing diagram of an interface between a primary system and an external system according to a preferred embodiment;

FIG. 4 is a method flow diagram for using an asynchronous interface according to a preferred embodiment; and

FIG. 5 is a block diagram of a typical interface between a primary system and an external system according to the prior art.

### BEST MODE FOR CARRYING OUT THE INVENTION

According to preferred embodiments, an asynchronous interface is described that uses vectored interface commands to reduce the latency of registered communication interface signals. The preferred embodiments include vectored command valid/acknowledge signal pairs along with a next command pair register to determine the next valid/acknowledge signal pair that will be used. In preferred embodiments, each side of the asynchronous interface independently tracks the next valid/acknowledge signal pair that will be used. Prior art designs do not have vectored command valid/acknowledge pairs and must communicate the command number with extra signals. Further, the prior art designs don't independently track which command valid/acknowledge pair will be used and must wait for an acknowledge to send the next command to prevent the loss of the order of the commands.

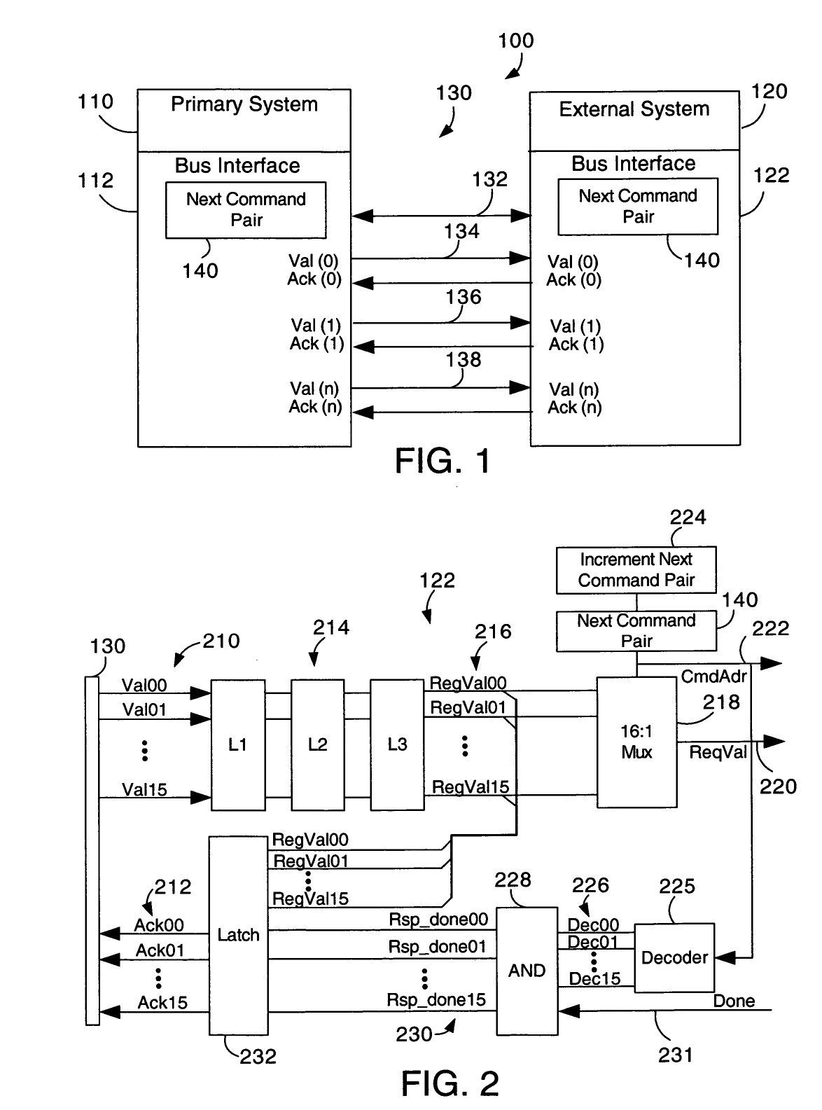

FIG. 1 represents a digital computer system 100 that has a primary system 110 with a bus interface 112 connected to an external system 120 with a bus interface 122 over a bus 130 according to preferred embodiments. In this digital computer system, the external system 120 is asynchronous to the primary system 110. In other words, the clock of the external system 120 is not tied to the clock mechanism of the primary system 110, but operates independently and asynchronously to the primary system 110. Signals from the primary system 110 to an external system 120 are then asynchronous inputs to the logic of the external system 120 and vise versa.

Again referring to FIG. 1, the bus 130 between the primary system 110 and the secondary system 120 of digital system 100 includes a general data bus 132 that contains typical data and command buses such as those used in prior art digital computer systems. Further, the bus 130 includes two or more command valid/acknowledge pairs. In the illustrated embodiment, 16 valid/acknowledge pairs are represented by Val(0)/Ack(0) pair 134, Val(1)/Ack(1) pair 136, and a Val(n)/Ack(n) pair 138.

Again referring to FIG. 1, the bus interface 112 of the primary system 110 and the bus interface 122 of the secondary system 120 in digital system 100 each include a next command pair register 140 according to preferred embodiments. The next command pair register holds a value for the next available command valid/acknowledge pair to be used for a new command. The next command pair register is incremented when a new command pair is used. In preferred embodiments, the next command pair register is a circular queue so the command pairs can be reused as they are acknowledged.

FIG. 2 shows a more detailed block diagram according to preferred embodiments of a bus interface such as the bus interface 122 introduced above. The bus interface 122 has a bus 130 that includes 16 command valid inputs 210 and 16 command acknowledge outputs 212. These command valid inputs 210 and command acknowledge outputs 212 represent the command/acknowledge pairs 134, 136, and 138 illustrated in FIG. 1. The command valid inputs 210 are passed through a series of registers 214 to synchronize the command valid inputs and prevent metastability as described above with reference to the prior art.

Again referring to FIG. 2, the outputs of the series of registers 214 that register the command valid inputs 210 are an array of signals 216 called Registered Valid (RegVal00 through RegVal15). The Registered Valid signals 216 are applied to the inputs of a multiplexor 218. The output of the multiplexor 218 is the command request valid signal 220 that is used for handshaking of the next command cycle on the bus 130. The selection for multiplexor 218 is the command address signal 222 provided by the next command pair register 140. The next command pair register 140 is incremented by the increment next command pair circuit 224. The increment next command pair circuit is controlled by a micro-controller or processor (not shown) working in conjunction with the interface 122.

Again referring to FIG. 2, the command address signal 222 in the preferred embodiment is also used to determine which of the acknowledge signals 212 to respond on the bus 130. The command address signal 222 is connected to a decoder 225 that outputs 16 decode acknowledge signals (Dec00 . . . Dec15) 226. The decode acknowledge signals 226 are applied to an AND circuit 228. The AND circuit 228 has 16 AND gates that AND each of the decode acknowledge signals 226 with a Done single 231. The Done signal 231 is driven by the processor (not shown) to indicate that the current command is done being processed. The decode acknowledge signals 226 AND'd with the Done single 231 produce 16 response done signals (Rsp_done00 . . . . Rsp_done15) 230. The response done signals 230 are used to set the corresponding bits of latch 232. The bits set by the response done signals 230 in latch 232 drive the command acknowledge signals 212 to the bus 130 as described further above. The acknowledge signals 212 are reset to the un-asserted state by the registered valid signals 216 connected to latch 232. When the receiving interface detects an acknowledge signal 212, it then drops the corresponding command valid signal 210. The corresponding registered valid signal 216 will then drop after propagating through the registers 214. The registered valid signal 216 that goes from an asserted to an un-asserted state will then cause the corresponding acknowledge signal 212 to be reset to the un-asserted state.

The overall operation of the interface 122 in FIGS. 1 and 2 will now be described. When a new command needs to be communicated from the primary system 110 to the secondary system, or vise versa, the command is assigned the next sequential number in the next command pair register 140 and the respective command valid, Val(n), is asserted. The receiving domain serially registers the signal before using it to avoid metastability. When a second command needs to be sent, it does not wait for Ack(n) to be returned which indicates command(n) has been completed. It can send Val(n+1) immediately since both clock domains independently keep track of which valid/acknowledge signal pair will contain the next command (n+1). This allows command valids to be pipelined and hides any latency introduced by the serial registers that are utilized to reduce metastability.

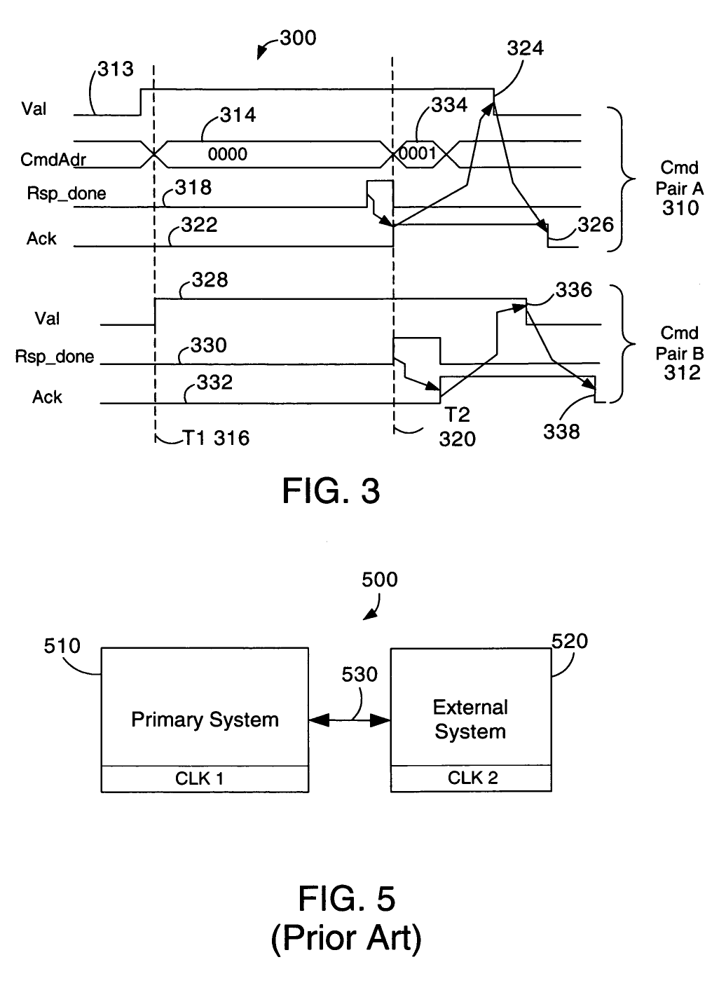

Referring now to FIG. 3, a timing diagram illustrates the timing of the operation of the circuit as described above. The timing diagram illustrates a valid/acknowledge command pair A 310 and a valid/acknowledge command pair B 312. For this illustration, the command valid signals are from a primary system 110, and the command acknowledge signals are generated by an external system 120. The valid command 313 is first asserted on the bus to indicate a command address 314 is valid and ready to send a first command as shown by CmdAdr=0000 (shown at location 314) being asserted at time T1 (316). The handshaking to complete the command transfer is indicated by the arrows. First the response done 318 signal is asserted by the receiving processor (not shown) when the command has been processed. The response done 318 generates an acknowledge when latched as described above at time T2 320. When the acknowledge is recognized, the primary system drops the command valid 311 at transition 324. The bus interface of the external system 120 then drops the acknowledge 322 at transition 326.

Again referring to FIG. 3, the valid/acknowledge command pair B 312 illustrates another command transaction on the bus to illustrate according to preferred embodiments. The valid command 328 signal for this second valid acknowledge command pair is first asserted to begin the command handshaking on the bus to send a second command as shown by CmdAdr 0001 334 being asserted at time T2 320. The handshaking to complete this command transfer begins after the response done is completed on the previous command pair. The response done for command pair B generated by the receiving processor (not shown) generates an acknowledge as described above. When the acknowledge 332 is recognized, the primary system drops the command valid 328 at transition 336. The bus interface of the external system 120 then drops the acknowledge 332 at transition 338.

It can be seen in FIG. 3 that the delay caused by registering the handshaking signals of subsequent commands to the first command is masked such that the registering delay of subsequent command valid/acknowledge pairs does not impact the overall performance of the system. For example, the delay in registering the command valid signal 328 of command pair B 312 is done while the previous command 0000 is being processed. Further, the handshaking to complete the transaction of command pair B is overlapped but delayed with respect to the handshaking for command pair A as shown in FIG. 3.

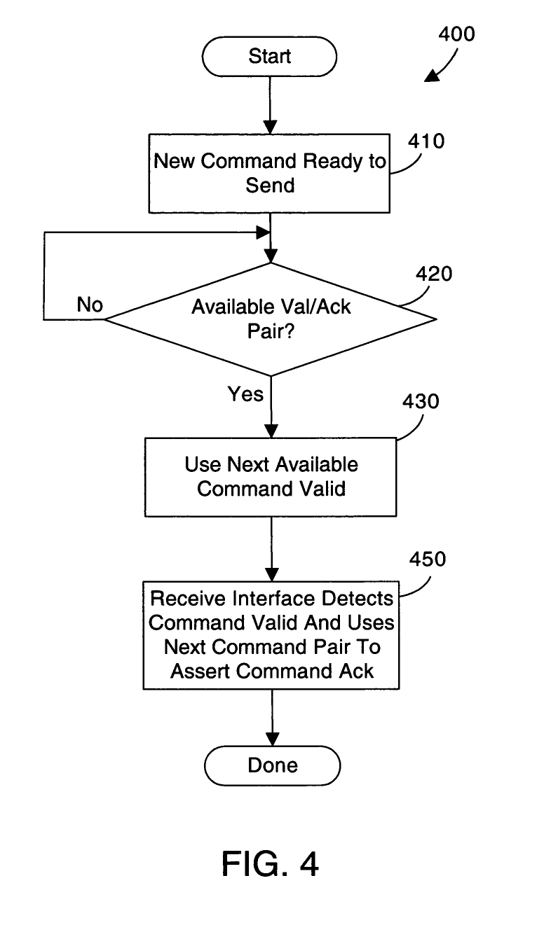

Referring now to FIG. 4, a flow diagram shows a method 400 to send a command over a bus in a digital computer system according to a preferred embodiment. The method first receives a new command that is ready to send over the bus (step 410). A check is then made to determine if there is an available valid/acknowledge pair available (step 420). If there is no valid/acknowledge pair available (step 420=no) then step 420 is repeated. If there is a valid/acknowledge pair available (step 420=yes) then the next available command valid signal of the pair is used to start a command sequence (step 430). The receiving interface then detects the command valid signal and uses the next command pair signal stored in the next command pair register to respond and assert the corresponding command acknowledge signal (step 450). The method is then done.

According to the preferred embodiments, an asynchronous interface is described that uses vectored interface commands to reduce the latency of registered communication interface signals. In preferred embodiments, vectored commands are communicated between clock domains with handshake command signals comprising command valid and command acknowledge signals. The vectored valid/acknowledge command pairs allows command valid signals to be pipelined to mask latency introduced by the serial metastability registers to optimize system performance.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. A digital system with an asynchronous interface from a primary system to an external system, the digital system comprising:
a first interface in the primary system connected to a second interface in the external system by a bus comprising a plurality of signals including a plurality of command valid/acknowledge pairs; and
a next command pair register located in the first and second interfaces that stores the next command valid/acknowledge pair available to use to allow the bus to initiate a second command using a next available command valid/acknowledge pair prior to the complete execution of a first command.

2. The digital system of claim 1 wherein the first and second interfaces further comprise multiple registers that register the plurality of command valid/acknowledge pairs.

3. The digital system of claim 1 wherein the first and second interfaces further comprise a multiplexor to select a valid command input from the plurality of valid/acknowledge pairs depending on the value of the next command pair register.

4. The digital system of claim 1 wherein the first and second interfaces further comprise a decoder to drive an acknowledge output of one of the plurality of valid/acknowledge pairs depending on the value of the next command pair register.

5. An asynchronous digital interface for communicating over a bus to an external computer comprising:
a plurality of inputs and outputs on the interface to the bus including a plurality of command valid/acknowledge pairs; and
a next command pair register located in the interface that stores the next command valid/acknowledge pair available to use to allow the bus to initiate a second command using a next available command valid/acknowledge pair prior to the complete execution of a first command.

6. The interface of claim 5 further comprising multiple registers that register the plurality of command valid/acknowledge pairs to reduce metastability.

7. The interface of claim 5 further comprising a multiplexor to select a valid command input from the plurality of valid/acknowledge pairs depending on the value of the next command pair register.

8. The interface of claim 5 further comprising a decoder to drive an acknowledge output of one of the plurality of valid/acknowledge pairs depending on the value of the next command pair register.

9. A method of communicating over a bus in a digital system with an asynchronous interface from a primary system to an external system comprising the steps of:
receiving a command to send over the bus;
finding a next available command valid/acknowledge pair from a next command pair register on the primary system;
using the next available command valid/acknowledge pair to send a first command valid signal on the bus for a first command transaction;
receiving the command valid signal on a bus interface on the external system; and
using a next available command pair from a next command pair register on the bus interface of the external system to assert a command acknowledge signal.

10. The method of claim 9 further comprising further comprising the step of sending a second command valid on another next available command valid/acknowledge pairs prior to completing execution of the first command transaction.

11. The method of claim 9 further comprising further comprising the step of multiple registering the plurality of command valid/acknowledge pairs to reduce metastability.

12. The method of claim 9 further comprising the step of using a multiplexor to select a valid command input from the plurality of valid/acknowledge pairs depending on the value of the next command pair register of the interface of the external system.

13. The method of claim 9 further comprising the step of using a decoder to drive an acknowledge output of one of the plurality of valid/acknowledge pairs depending on the value of the next command pair register of the interface of the external system.
